(19) United States
(12) Patent Application Publication
(10) Pub. No.: US 2026/0145843 A1
(43) Pub. Date: May 28, 2026

(54) FASTENER ORGANIZER APPARATUSES AND METHODS OF USE THEREOF

(71) Applicants: Steven James Shaffstall, Trabuco Canyon, CA (US); Scott Duane Shaffstall, Silverado, CA (US); Christopher Philip James Lam, Newport Beach, CA (US)

(72) Inventors: Steven James Shaffstall, Trabuco Canyon, CA (US); Scott Duane Shaffstall, Silverado, CA (US); Christopher Philip James Lam, Newport Beach, CA (US)

(21) Appl. No.: 19/391,953

(22) Filed: Nov. 17, 2025

Related U.S. Application Data
(60) Provisional application No. 63/724,413, filed on Nov. 25, 2024.

(51) Int. Cl. B65D 25/00

(52) U.S. Cl. CPC B65D 25/005

(57) ABSTRACT

Fastener organizer apparatuses are disclosed for retaining fasteners while disassembling and reassembling mechanical components. Such an apparatus may comprise at least one or more fastener receptacle units operative to be coupled with one another, wherein each unit comprises a base portion and a retaining material defining one or more orifices operative each being independently operative to receive and retain a fastener. As a mechanical component is being disassembled, a user may emplace the fasteners in the retaining material such that each fastener is retained by an orifice of the retaining material. The user may annotate the retaining material and imprint the mechanical component onto the retaining material to provide information on how to properly reassemble the mechanical component. Thereafter, the mechanical component can be reassembled by separating the fasteners from the retaining material and using those fasteners according to the information annotated on the retaining material.

### CROSS-REFERENCE TO RELATED APPLICATIONS

This application relates to and claims the benefit of U.S. Provisional Application No. 63/724,413 filed Nov. 25, 2024, and entitled “MECHANIC'S BOLT ORGANIZER,” the entire disclosure of which is hereby wholly incorporated by reference.

### STATEMENT RE: FEDERALLY SPONSORED RESEARCH/DEVELOPMENT

Not Applicable

### BACKGROUND

### 1. Field of Invention

The present application relates to organizing fasteners when disassembling and reassembling mechanical components from automobiles, watercraft, airplanes, and more. More specifically, the present application relates to fastener organizing apparatuses for receiving and retaining fasteners in orifices defined by a retaining material to permit a mechanic to efficiently organize and identify particular fasteners when disassembling and reassembling mechanical components.

### 2. Related Art

Mechanical components, including parts associated with vehicle engines, transmissions, pumps, and more, require periodic servicing as they experience wear and tear during use. Over time, these mechanical components have become increasingly complex, and as such, the various fasteners (e.g., nuts, bolts, screws, etc.) which hold these mechanical components together have taken more specialized and varied forms. When servicing mechanical components, which typically entails disassembly via loosening its associated fasteners and thereafter reassembling the mechanical component with the same or similar fasteners, it can prove difficult to ensure that the fasteners are placed in their correct locations or are otherwise configured correctly during reassembly. As an example, eight otherwise identical bolts holding together an engine side case may have differing lengths, or certain bolts may require a copper washer. Mistakenly using even one wrong fastener when reassembling a mechanical component can result in, at one end of the spectrum, the need to again disassemble and then properly reassemble, or, at the other end, failure of the mechanical component when in use.

Some methods exist for organizing fasteners in a manner to ensure a mechanic correctly reassembles the mechanical component, but such methods have flaws. Crude methods include laying fasteners on the floor or in a small pile of like-fasteners. It is not hard to see that this creates a high risk of losing certain fasteners or losing track of where a fastener is meant to go in its mechanical component, and moreover it does not provide a receptacle for temporary storage. The first and last of these issues have been addressed by placing fasteners within individual containers like bowls, bags, or boxes which could be labeled, but the risk of losing track of where the fastener is meant to go remains. The most sophisticated method comprises the drawing of a basic outline of the mechanical component being serviced onto a sheet of cardboard, paper, or foamboard and annotating indicators of where each fastener is meant to go; a user can then punch holes into the sheet and insert the fasteners into those holes. The issue with this method lies with its lack of durability and reusability, as new sheets are needed for new sets of mechanical components. As such, there is a need in the art for improved methods and apparatuses which permit the efficient organization of fasteners when servicing mechanical components and which are adaptable for use with a variety of mechanical components.

### BRIEF SUMMARY

To solve these and other problems, fastener organizer apparatuses and methods in which such systems can be utilized are disclosed to facilitate an efficient and robust procedure for disassembling and properly reassembling mechanical components. A fastener organizer may comprise a single fastener receptacle unit or two or more fastener receptacle units. Each of the fastener receptacle units present could comprise a base portion and a retaining material secured by the base portion. The retaining material could define one or more orifices each being independently operative to receive and retain a fastener. The fastener receptacle units may be operative to be coupled with one another to form a fastener organizer apparatus. In the event that the fastener organizer apparatus is comprised of at least five fastener receptacle units, the fastener organized apparatus may have a cube-like geometry.

The retaining material may comprise a high-density foam material. Fasteners which the retaining material could receive and retain within its orifices include screws, bolts, washers, nuts, pins, rivets, anchors, clips, studs, and nails. Such fasteners may be associated with mechanical components which form part of an engine, a transmission, a motor, a pump, a valve, a turbine, or a carburetor associated with a machine, such as an automobile (including motorcycles), a watercraft, an aircraft, a lawn mower, construction equipment, machines associated with power utilities, or electronic devices (such as consumer electronics devices).

The fastener receptacle units may further comprise a frame which further secures the retaining material. The frame may have a surface, such as dry-erase surface, upon which one may make markings, such as by annotating indicators.

Fastener receptacle units may be coupled with each other via the base portions of those units defining a mortice operative to receive a tenon associated with the base portion of another unit and/or comprising a tenon operative to be received by a mortice associated with the base portion of another fastener receptacle unit. Alternatively, or additionally, the fastener receptacle units may define a series of openings which are operative to receive a pin fastener, such as a ball-lock pin. In particular, the frame and base portion of one unit may define openings and a base portion of another unit may define another opening, and those two units may be coupled with each other via each of those openings receiving the same pin fastener.

A fastener organizer apparatus could further include one or more structural units, such as a bottom unit, comprised of a base portion. This structural unit may couple with the fastener receptacle units in a similar manner to how those units may couple with one another. The structural unit may be capable of supporting the weight of the fastener organizer apparatus when the fastener organizer apparatus is placed on a flat surface and oriented such that the structural unit is adjacent to the flat surface. The structural unit may have an inner surface and an outer surface, and the inner surface could be operative to receive an accessory feature for disassembling, servicing, or reassembling a mechanical component.

When a mechanic or other type of use is disassembling a mechanical component, they may retain one or more fasteners obtained from such disassembly with the orifices of the retaining material. They may annotate the frame and/or the retaining material to indicate where certain fasteners are meant to go when reassembling the mechanical component, what order the fasteners are to be used when reassembling, and more. Annotations on the retaining material may comprise an imprint of the mechanical component itself, which could be accomplished by tracing the mechanical component onto the retaining material or by affixing a pictorial label thereon. When the mechanical component is ready to be reassembled, which may be the case after sufficient servicing has been carried out, the user may separate the fasteners from their retaining materials and reassemble the mechanical component with aid of any annotations made to ensure that the mechanical component is properly assembled.

All of these embodiments are contemplated to be within the scope of this disclosure. These and other embodiments will become readily apparent to those skilled in the art from the following detailed description of the preferred embodiments having reference to the attached figures, the disclosure not being limited to any particular preferred embodiment.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a top perspective view of an embodiment of a fastener organizer apparatus according to this present disclosure;

FIG. 1B is a bottom perspective view of the fastener organizer apparatus of FIG. 1A;

FIG. 1C is a top perspective exploded view of the fastener organizer apparatus of FIG. 1A;

FIG. 2A is a front perspective view of an embodiment of a connector;

FIG. 2B is a back perspective view of the connector of FIG. 2A;

FIG. 3A is a front perspective exploded view of an embodiment of a fastener receptacle unit;

FIG. 3B is a back perspective exploded view of the fastener receptacle unit of FIG. 3A;

FIG. 4A is a front perspective view of an embodiment of a fastener receptacle unit holding a fastener;

FIG. 4B is a side cross sectional view of the fastener receptacle unit of FIG. 4A along line 4B-4B in FIG. 4A;

FIG. 4C is a top view of the fastener receptacle unit of FIG. 4A holding and additional fastener;

FIG. 4D is a top view of the fastener receptacle unit of FIG. 4A holding four fasteners and having an imprint of a mechanical component;

FIG. 5A is a top perspective view of an embodiment of a structural unit according to this present disclosure;

FIG. 5B is a side view of the structural unit of FIG. 5A;

FIG. 5C is a top view of the structural unit of FIG. 5A; and

FIG. 5D is a side cross sectional view of the structural unit of FIG. 5A along line 5D-5D of FIG. 5C.

Common reference numerals are used throughout the drawings and the detailed description to indicate the same elements.

### DETAILED DESCRIPTION

The following disclosure encompasses various embodiments of fastener organizing apparatuses and methods of use thereof which may allow for a mechanic to efficiently service mechanical components with minimal risk of improper reassembly of those mechanical components. A fastener organizer apparatus may comprise one or more fastener receptacle units, with each fastener receptacle unit present having a base portion and a foam retaining material defining one or more orifices; these fastener receptacle units could be separate units which may be coupled with one another to form the fastener organizer apparatus. One may annotate the retaining material to impart information related to the mechanical component being serviced, such as indicators corresponding to certain fasteners of the mechanical component and/or an imprint of the mechanical component itself. This may permit a mechanic to emplace fasteners obtained when disassembling the mechanical component in the foam retaining material such that they can readily ascertain how to correctly use those fasteners to reassemble the mechanical component. Thus, there is minimal risk of incorrectly reassembling the mechanical component that may otherwise require another round of disassembly and reassembly or lead to operational failure of the machine associated with the mechanical component.

This description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

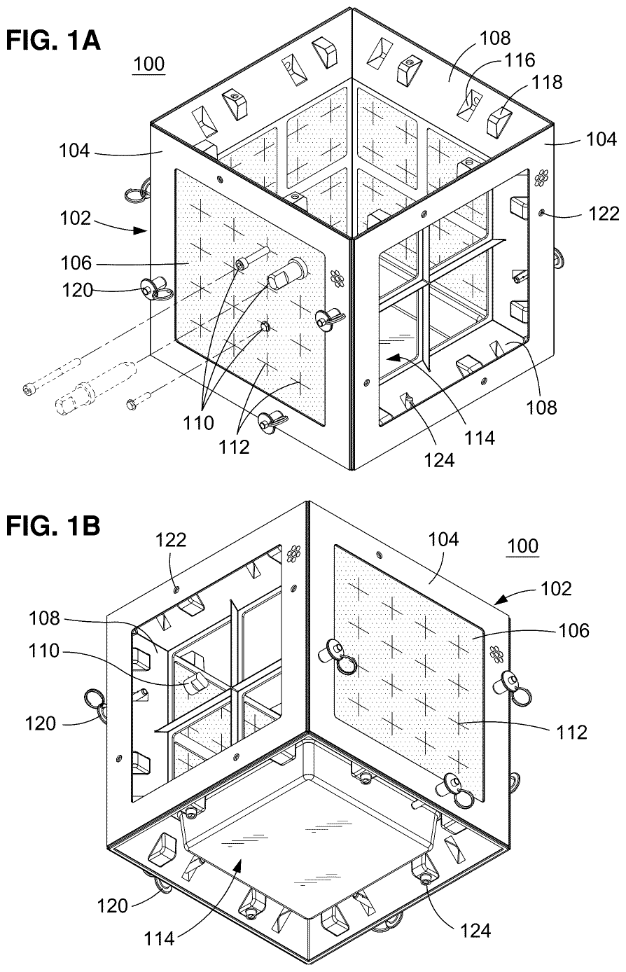

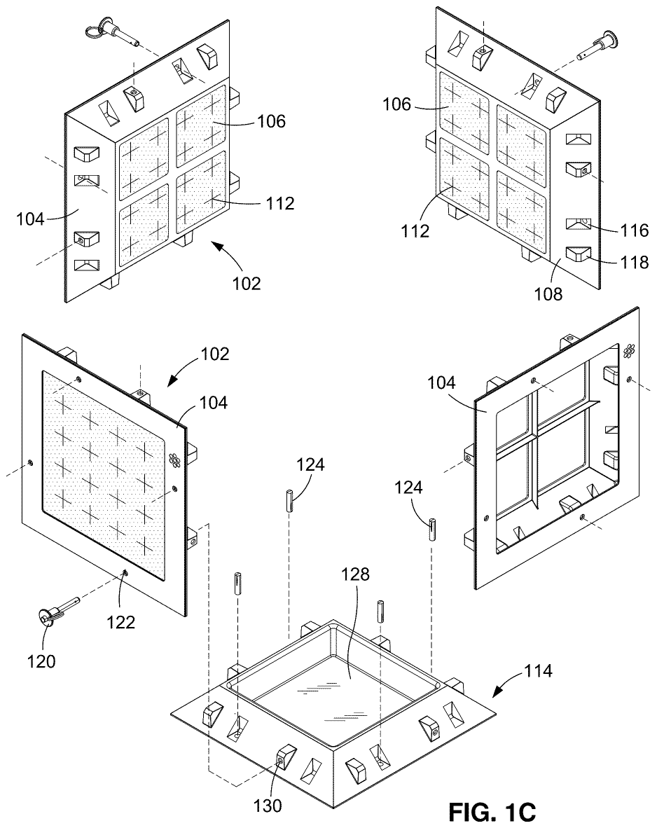

Referring first to FIGS. 1A-1C, a top perspective view, a bottom perspective view, and a top perspective exploded view respectively of an embodiment of a fastener organizer apparatus according to this present disclosure is shown. A fastener organizer could take the form of a faster organizer apparatus 100, which may be comprised of one or more fastener receptacle units 102 and potentially one or more structural units 114. That said, a fastener organizer may be comprised of just one fastener receptacle unit 102. Each fastener receptacle unit 102 may be comprised of a base portion 108, a retaining material 106, and a frame 104. There may be one or more orifices 112 defined by the retaining material 106 which are each operative to receive and retain a fastener 110. The elements of the fastener receptacle units 102 and the structural unit 114 will be discussed in more detail in relation to the other figures of this disclosure.

The fastener receptacle units 102 and the structural units 114 may initially be separate from each other and could be operative to be coupled with one another to assemble the fastener organizer apparatus 100. Amongst other ways of designing the units 102, 114, each of the units 102, 114 may comprise tenons 118 that may be received by mortices 116, or define such mortices 116 to be received by tenons 118, or have both such specifications. One can thus cause two units 102, 114 to couple by emplacing them relative to each other such that the mortices 116 receive their respective tenons 118. Alternatively, or additionally, the units 102, 114 could define openings 122, 130, 132, 134 which are operative to receive a fastener, such as a pin fastener 120 (e.g., a ball-lock pin) or a bolt 124, for the purposes of coupling the units 102, 114 with each other; these openings 122, 130, 132, 134 will be discussed further later in this disclosure.

Whichever way the units 102, 134 are designed to couple with each other, the units 112, 134 may form a fastener organizer apparatus 100 of a given geometry. The embodiment shown in FIGS. 1A and 1B are comprised of four fastener receptacle units 102 and one structural unit 114 to form a fastener organizer apparatus of a cube-like geometry. The units 102, 114 may be designed as modular units such that they are sized like one another and that any given unit 102, 114 can be substituted for another unit 102, 114 and form a fastener organizer apparatus 100 of similar geometry. For instance, the four fastener receptacle units 102 in the embodiment shown in FIGS. 1A-1C, which could individually be designated as units A, B, C, and D, may be capable of coupling with each other at right angles such that unit A is coupled to unit B on one side and unit D on the other side, unit B is coupled to unit A on one side and unit C on the other side, unit C is coupled to unit B on one side and unit D on the other side, and unit D is coupled to unit C on one side and unit A on the other side. If these units 102 are interchangeable, units A and B could swap places such that unit B is now coupled with units D and A while unit A is now coupled with units B and C while achieving a similar cube-like geometry as before.

At least some of the units 102, 114, however, could alternatively be sized and configured different from one another, and/or the manner in which at least some of the units 102, 114 couple with each other may be configured, such that the fastener organizer apparatus 100 forms a unique geometry. For example, some units 102, 114 may differ in size and/or dimensions such that a rectangular prism-like geometry may be formed, or the angles at which the units 102, 114 couple with each other may be adjusted so that one can achieve a hexagonal arrangement. Additionally, the units 102, 114 could merely couple with each other in a manner where the coupled units are side-by-side with each other, thus forming a fastener organizer apparatus 100 having a more two-dimensional configuration. At minimum, a fastener organizer apparatus 100 can be assembled by coupling at least one unit 102, 114 with another unit 102, 114. The ultimate geometry chosen may reflect the mechanical components one intends to service with the fastener organizer apparatus 100.

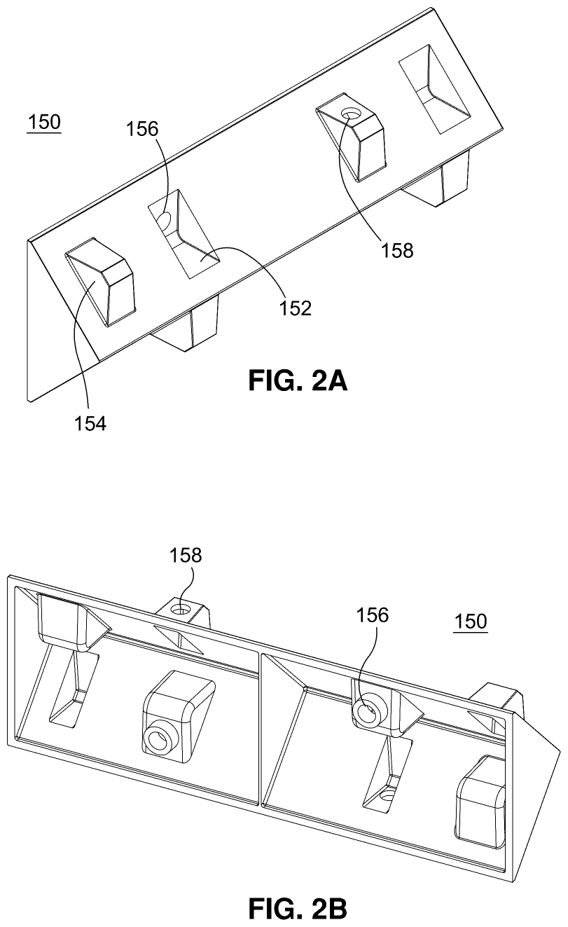

The units 102, 114 could also, or alternatively, be capable of coupling with a connector 150, such as the connector 150 shown in front and back perspective views in FIGS. 2A and 2B respectively. The connector 150 may have tenons 154, which could be received by a mortice 116 of a unit 102, 114, and/or define mortices 156, which could be capable of receiving a tenon 118 of a unit 102, 114 (although connectors 150 may also be capable of coupling with other connectors 150 in a similar manner). Coupling one or more units 102, 114 with a connector 150 may allow for fastener organizer apparatuses 100 of certain geometries to be assembled which the units 102, 114 may not be capable of achieving by coupling with one another. For instance, if two units 102, 114 which can couple with each other at right angles are coupled with a given connector 150, those units 102, 114 may form a fastener apparatus 100 in which those two units 102, 114 could be placed side-by-side and generally planar with each other. The connector 150 may define openings 156, 158, such as an opening 156 associated with a mortice 152 and/or an opening 158 associated with a tenon 154, and these openings 156, 158 may be configured similar to the aforementioned openings 122, 130, 132, 134 of the units 102, 114 for coupling the units 102, 114 with the connector 150 by using, for instance, a pin fastener 120 (e.g., a ball-lock pin) or a bolt 124.

The fastener organizer apparatus 100 may be assembled such that a unit 102, 114 which could otherwise be coupled with one or more other units 102, 114 may intentionally be absent, such as the case in the embodiment of FIG. 1A where a unit 102, 114 could be coupled, but is not coupled, at the top of the apparatus 100. This may be beneficial when one wishes to access the structural unit 114, and in particular an inner surface 128 thereof, the potential benefits of which will be detailed later in this disclosure. That said, a preferred embodiment of a fastener organizer apparatus 100 would be comprised of five fastener receptacle units 102 and one structural unit 114, similar to the embodiment shown in FIGS. 1A and 1B but with a fifth fastener receptacle unit 102 coupled on top of the unit. Additionally, a fastener receptacle unit 102 may have base portion 108 defining openings and/or not have a retaining material 106 (as is the case for one of the units 102 shown in FIGS. 1A-1C) to similarly grant one access to the structural unit 114. Coupling multiple fastener receptacle units 102 together may allow for multiple mechanical components to be serviced so that each mechanical component corresponds to a particular fastener receptacle unit 102.

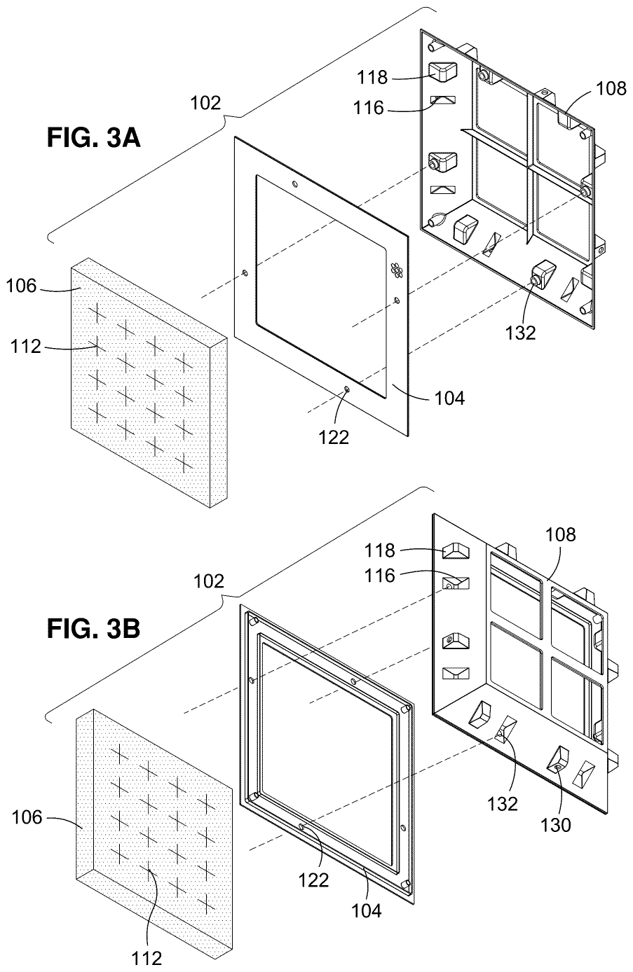

Turning now to FIGS. 3A and 3B, a front perspective exploded view and a back perspective exploded view respectively of an embodiment of a fastener receptacle unit are illustrated. A fastener receptacle unit 102 may be comprised of any combination of a base portion 108, a retaining material 106, and a frame 104. The base portion 108 may serve to secure the retaining material 106 and/or allow any units 102, 114 to couple with each other by having tenons 118 and/or defining mortices 116 (or other comparable features which may otherwise allow units 102, 114 to couple with each other).

The frame 104 may, alongside the base portion 108, secure the retaining material 106, which could come in the form of the frame 104 and base portion 108 sandwiching the retaining material. Additionally, the frame 104 could have a surface which could be capable of being annotated. As an example, the frame could be a dry-erase surface upon which a mechanic can write information using a chalk marker. A user may annotate this surface to provide relevant information such as the length of certain fasteners 110, whether certain fasteners 110 need a washer to properly reassemble the mechanical component, torque specifications, the sequence at which the fasteners 110 were removed from the mechanical component, the sequence at which the fasteners 110 are to be added back to the mechanical component when reassembling, and more. A marker may be chosen so that it imparts a more permanent annotation on the frame 104 (which may be desirable when a fastener receptacle unit 102 is to be used continuously for the same type of mechanical component over a prolonged period of time) or an annotation which is readily erasable.

The features of a fastener receptacle unit 102 may define openings 122, 130, 132 which could be operative to receive a pin fastener 120, such as a ball-lock pin, which may provide a further/alternative mechanism for coupling the units 102, 114. In particular, there may be an opening 122 defined by the frame 104, which could be referred to as a first opening 122, and an opening 132 defined by the base portion 108, which may be referred to as a second opening 132; the unit 102 may be constructed such that the first opening 122 and the second opening 132 are both operative to receive a pin fastener 120, even when the unit 102 is not coupled to any other units 102, 114. The base portion 108, or even the structural unit 114, may further define another opening 130, which may be referred to as a third opening 130; to couple two units 102, 114 with each other, a pin fastener 120 which has already been received by the first opening 122 and second opening 132 of one unit 102 may then be received by the third opening 130 of a separate unit 102, 114. This arrangement can be perceived in the fastener receptacle unit 102 in the bottom left of FIG. 1C, where a pin fastener 120 can be received by a first opening 122 and a second opening 132 (not shown) of a fastener receptacle unit 102 before being received by a third opening 130 associated with another unit (in this case, the structural unit 114). The openings 132, 130 of a base portion 108 of a fastener receptacle unit 102 may be associated with the tenons 118 and mortices 116, examples of which are shown in the figures.

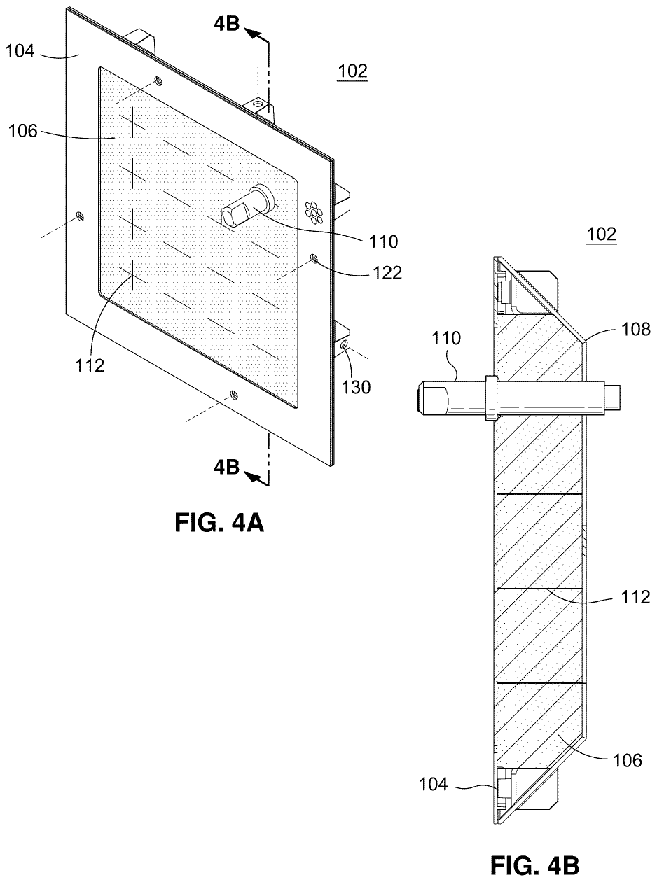

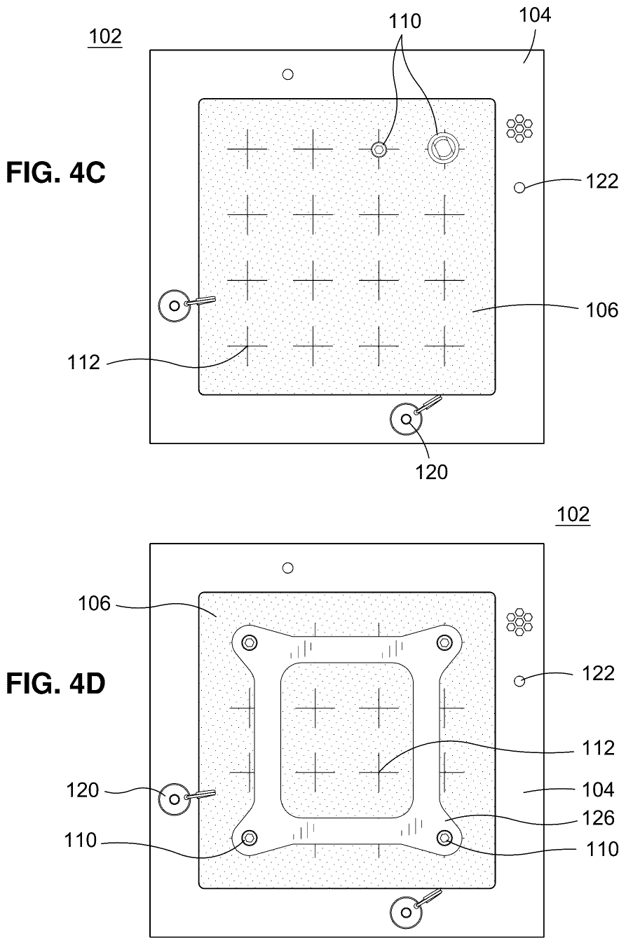

Referring now to FIGS. 4A-4D, a front perspective view and a side cross sectional view of an embodiment of a fastener receptacle unit retaining a fastener along line 4B-4B of FIG. 4A, as well as a top view of the fastener receptacle unit retaining and additional fastener and a top view of the fastener receptacle unit retaining four fasteners and having an imprint of a mechanical component. A fastener receptacle unit 102 may be capable of receiving and retaining a fastener 110. In particular, one or more orifices 112 defined by the retaining material 106 may each be independently capable of receiving and retaining a fastener 110. The orifices 112 could come in the form of one or more slits, such as two slits which intersect each other at approximately right angles, although the orifices could come in other linear and non-linear shapes. A retaining material 106 may be manufactured such that the retaining material 106 defines these orifices 112 by virtue of no retaining material 106 being present in certain areas and/or a user could make one or more of these orifices 112 themselves by puncturing the retaining material 106. Each orifice 112 may retain a fastener 110 by holding the fastener 110 in place via pressure and/or friction when the orifice 112 receives the fastener 110. The thickness, density, and material composition of the retaining material 106 may be selected so that the retaining material 106 may effectively receive and retain certain classes of fasteners 110. The retaining material 106 preferably comprises a high-density foam material, as that may allow for a wide variety of fasteners 110 to be retained by the retaining material 106, although the retaining material 106 may comprise other types of deformable or even suitable rigid materials which are capable of receiving and retaining fasteners 110. A retaining material 106 may be used several times to retain and hold various fasteners associated with different mechanical components being serviced, but one can replace the retaining material 106 of a fastener receptacle unit 102 with another retaining material 106 as they see fit.

A surface of the retaining material 106 may be capable of being annotated with a marker such that a user may impart information related to the fasteners to be retained in the retaining material 106 and/or the mechanical component to be serviced. This could even come in the form of imprinting a mechanical component onto the retaining material 106, such as by tracing the mechanical component onto the retaining material 106 with a marker, which could be done after the mechanical component has been disassembled to an extent that allows one to more easily do so. This may result in an imprint of a mechanical component 126 being imparted onto the retaining material 106, as shown in FIG. 4D. In this approach, one could optionally separate the retaining material 106 from the frame 104 and base portion 108 so that the mechanical component can be better imprinted thereon before securing the retaining material 106 between the frame 104 and base portion 108. Alternatively, the retaining material 106 could be premanufactured such that the outer surface of the retaining material 106 is colored to obtain some or all of the indicators one desires to have on their retaining material 106. As another alternative, a pictorial label representing the mechanical component being serviced may be affixed to the retaining material.

The orifices 112 may be capable of receiving a wide range of fasteners 110. Such fasteners 110 include, but are not limited to, washers, screws, bolts, nuts, pins, rivets, anchors, clips, studs, and nails. Furthermore, an orifice 112 may be capable of receiving relatively large and relatively small fasteners 110. For instance, all of the orifices 112 shown in FIG. 4C are configured identically to one another, and yet the orifices 112 can receive and retain fasteners 110 of relatively small and large size. That said, the orifices 112 of a retaining material 106 need not be configured identically to one another, and as such certain orifices 112 may be larger or smaller than others so that they may better accommodate particular fasteners 110. Additionally, while the orifices 112 shown in these figures are arranged in an evenly-spaced grid-like pattern, the retaining material 106 may be configured such that the orifices 112 are distributed and spaced apart in any conceivable manner. It is contemplated that the retaining material 106 can thus be designed such that it is adapted for a class of mechanical components to be serviced in connection with the fastener receptacle unit 102. For example, if one is contemplating using a fastener receptable unit 102 to service a certain mechanical component, they may design the retaining material 106 such that the spatial relationship of its orifices 112 correspond to the spatial arrangement of fasteners 110 on that mechanical component when that component is fully assembled. Suitable mechanical components which can be serviced using these fastener receptacle units include parts associated with engines, pumps (including fuel pumps and water pumps), motors, carburetors, transmissions, valves, turbines, and more. These mechanical components may be part of a larger machine, such as an automobile (e.g., cars, motorcycles, trucks), a watercraft, an aircraft, a lawn mower, machines associated with power utilities, construction equipment, etc., or even smaller machines like electronic devices (e.g., consumer electronics device). Thus, it is contemplated that this disclosure can be used when servicing a variety of machines, including those not explicitly mentioned in this disclosure and those which are conceived of in the future.

When using a fastener receptacle unit 102, one may use the fasteners 110 retained by the retaining material 106 to hold a mechanical component. This can allow one to better annotate the retaining material 106 with information related to how the fasteners 110 related to the mechanical component 126 and/or make a proper imprint 126 of the mechanical component.

A mechanic can be afforded great convenience when using a fastener receptacle unit 102 to service a mechanical component. While they are disassembling the component, they may annotate information on the plate 104 and further annotate areas on the retaining material 106 to indicate where certain fasteners 110 are placed and/or where in the component the fastener 110 came from. The mechanic may then place the fasteners 110 removed from the component in the fastener receptacle unit 102 in their respective locations on the retaining material 106 such that each fastener 110 is received by and retained within the orifices 112 of the retaining material 106. A mechanic may take great advantage of a fastener receptacle unit 102 having such annotations or imprints, as they can readily ascertain how to organize the fasteners 110 on the retaining material 106 and where to use those fasteners 110 to correctly reassemble the mechanical component once it has been adequately serviced. When the mechanic is ready to reassemble the mechanical component, they may refer to their annotations and the arrangement of the fasteners 110 on the retaining material 106 to instruct them on how to properly reassemble the mechanical component. Of course, a mechanic need not reuse every fastener 110 which was present in the original mechanical component (in case one or more of those fasteners 110 needs to be replaced), and in such cases the mechanic could provide new fasteners 110 yet still use the fastener receptacle unit 102 to receive and retain those new fasteners 110 to nonetheless ensure the mechanic is informed as to where and how to use those fasteners 110. In either event, likelihood that the mechanic can achieve a proper placement of fasteners 110 can be dramatically increased with such a system.

When using a fastener organizer apparatus 100 comprised of multiple fastener receptacle units 102, each retaining material 106 and its associated plate 104 can annotated according to different mechanical component to be serviced. Thus, as a machine is being serviced and as separate mechanical components are removed, one can successively annotate and imprint/hold each mechanical component on a different retaining material 106. Such a fastener organizer apparatus 100 can thus be effectively used to service multiple mechanical components each associated with the same machine and each having their own fasteners associated therewith.

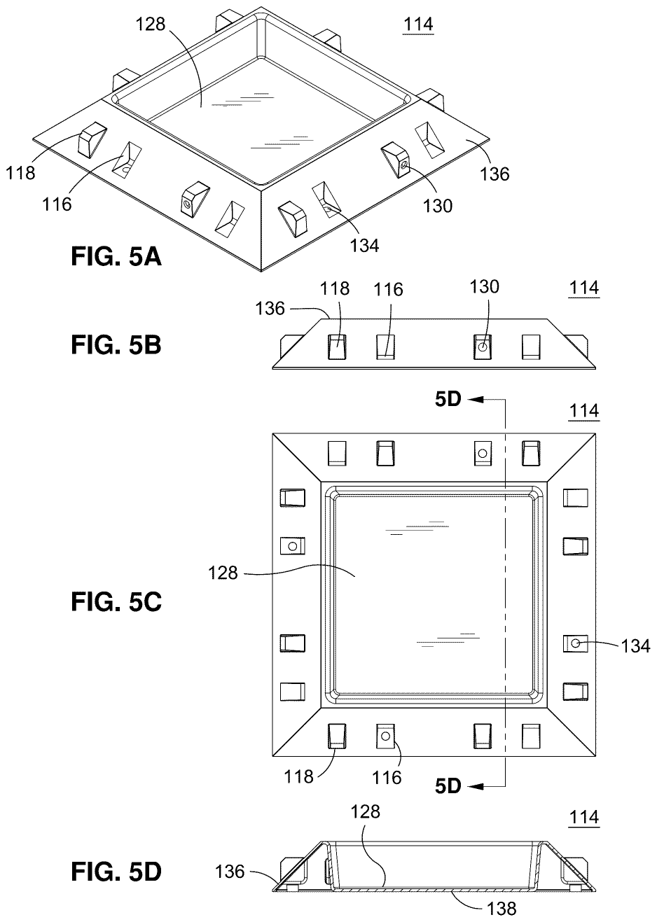

Turning now to FIGS. 5A-5C, a top perspective view, a side view, a top view, and a side cross sectional view along line 5D-5D of FIG. 5C of an embodiment of a structural unit according to this present disclosure is shown. A structural unit 114 may be comprised of a base portion, which may be configured similar to the base portion of a fastener receptacle unit 102. A structural unit 114 may be operative to couple with one or more of the fastener receptacle units 102 and/or with one or more other structural units 114 to form a fastener organizer apparatus 100. If configured similarly to a particular fastener receptacle unit 102, a structural unit 114 may be substituted for that fastener receptacle unit 102 in a fastener organizer apparatus 100. To couple the structural unit 114 with other units 102, 114, the structural unit 114 may contain tenons 118, define mortices 116, and/or define openings 130 for receiving a pin fastener, all of which may be configured and used in the same manner as the tenons 118, mortices 116, and openings 130 discussed above in relation to the fastener receptacle units 102.

A structural unit 114 may be designed as a bottom unit. In particular, a bottom unit may be capable of supporting the weight of a fastener organizer apparatus 100 when the apparatus 100 is placed on a flat surface and is oriented such that the bottom unit is adjacent to that flat surface. If necessary for a bottom unit to function in this matter, the structural unit 114 may define openings 134 for receiving a bolt 124, as using pin fasteners 120 like ball-lock pins with these openings may impede this result. If that is not a concern, these openings 134 can be structured like and function like the openings 122, 132 defined by the frame 104 and base portion 108 of the fastener receptacle unit 102 which receive pin fasteners 120 to couple units 102, 114 with each other.

A structural unit 114 could have an inner surface 128 and an outer surface 138. In embodiments where the structural unit 114 functions as a bottom unit, the outer surface 138 may contain features for providing more structural stability to the apparatus 100, such as an anti-slip surface or shock-absorbing feet. The inner surface 128 may be configured to receive and hold accessory features one may rely on when disassembling, servicing, and reassembling mechanical components. For instance, the inner surface 128 may comprise or define features for receiving tools (such as sockets, socket extensions, screwdrivers, and/or wrenches), markers (e.g., grease pencils, chalk markers), labeling strips, an illumination feature (which could come in the form of a detachable or integrated work light or light strip), auxiliary trays, magnifiers, or device holders. The inner surface 128 could have an embedded magnetic strip, plate, or pocket to secure materials like ferrous fasteners, washers, or clips. Additionally, the inner surface 128 could define a recessed slot for receiving a printed card, torque specification sheet, sequence card, etc. for reference when one is assembling and disassembling mechanical components. One could also incorporate an identifier into the inner surface 128, such as a printed QR code, an embedded NFC chip, etc. which directs a user to digital manuals, torque specifications, exploded diagrams relevant to the mechanical components, and more. The inner surface could also hold a removable or integrated liner, tray, and/or drainage features for capturing fluids, oils, or debris from the mechanical components being serviced. Finally, the inner surface 128 could define a cavity which may be sealed with a latch or a locking mechanism so as to store specialty fasteners which one does not wish to retain in the orifices 112 of the apparatus 100. The inner 128 and/or outer 138 surfaces may have handles, straps, and/or attachment mounts to aid one in transporting the apparatus 100.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. A fastener organizer comprising:
a fastener receptacle unit, the fastener receptacle unit comprising:
a base portion; and
a retaining material secured by the base portion, the retaining material defining one or more orifices, each orifice being independently operative to receive and retain a fastener.

2. A fastener organizer comprising:
at least two fastener receptacle units, each fastener receptacle unit comprising:
a base portion; and
a retaining material secured by the base portion, the retaining material defining one or more orifices, each orifice being independently operative to receive and retain a fastener;
wherein the at least two fastener receptacle units are operative to be coupled with one another to form a fastener organizer apparatus.

3. The fastener organizer of claim 2, wherein the fastener organizer comprises:
at least five fastener receptacle units;
wherein the at least five fastener receptacle units are operative to be coupled with one another to form the fastener organizer apparatus.

4. The fastener organizer of claim 2, wherein the retaining material comprises a foam material.

5. The fastener organizer of claim 2, wherein each orifice of each of the retaining materials is independently operative to receive at least one of the following fasteners: a screw, a bolt, a washer, a nut, a pin, a rivet, an anchor, a clip, a stud, a nail.

6. The fastener organizer of claim 2, wherein the base portion of each of the at least two fastener receptacle units: defines a mortice operative to receive a tenon associated with the base portion of another fastener receptacle unit, comprises a tenon operative to be received by a mortice associated with the base portion of another fastener receptacle unit, or both; and
wherein the coupling of the at least two fastener receptacle units comprises the mortice of one fastener receptacle unit receiving the tenon of another fastener receptacle unit.

7. The fastener organizer of claim 2, wherein the at least two fastener receptacle units each further comprise:
a frame, the frame further securing the retaining material.

8. The fastener organizer of claim 7, wherein the frame of each of the at least two fastener receptacle units defines a first opening operative to receive a pin fastener;
wherein base portion of each of the at least two fastener receptacle units defines a second opening operative to receive the pin fastener and a third opening operative to receive the pin fastener, the first opening of the frame and the second opening of the base portion both being operative to receive the same pin fastener when the fastener receptacle unit is not coupled with another fastener receptacle unit; and
wherein the coupling of the at least two fastener receptacle units comprises the first and second openings of one fastener receptacle unit and the third opening of another fastener receptacle unit receiving the same pin fastener.

9. The fastener organizer of claim 2, wherein the fastener organizer further comprises:
a structural unit, the structural unit comprising:
a base portion;
wherein the structural unit is operative to couple with the at least two fastener receptacle units to further form the fastener organizer apparatus.

10. The fastener organizer of claim 9, wherein the structural unit is capable of supporting the weight of the fastener organizer apparatus when the fastener organizer apparatus is placed on a flat surface and oriented such that the structural unit is adjacent to the flat surface.

11. A method of organizing fasteners, the method comprising the steps of:
providing a fastener organizer, the fastener organizer comprising:
at least two fastener receptacle units, each fastener receptacle unit comprising:
a base portion; and
a retaining material secured by the base portion, the retaining material defining one or more orifices, each orifice being independently operative to receive and retain a fastener;
wherein the at least two fastener receptacle units are operative to be coupled with one another to form a fastener organizer apparatus;
assembling the fastener organizer apparatus by coupling the at least two fastener receptacle units with one another; and
retaining one or more fasteners with the one or more orifices of the retaining materials such that each of the one or more fasteners is independently received by an orifice among the one or more orifices.

12. The method of claim 11, wherein the one or more fasteners comprise one or more fasteners previously removed from a mechanical component that has been at least partially disassembled.

13. The method of claim 12, wherein the method further comprises a step of:
separating at least one of the one or more fasteners previously removed from the mechanical component from the fastener organizer apparatus such that the at least one of the one or more fasteners previously removed from the mechanical component is not retained by any of the retaining materials; and
at least partially reassembling the mechanical component with the at least one of the one or more fasteners previously removed from the mechanical component.

14. The method of claim 12, wherein the mechanical component is a part associated with engine, a transmission, a motor, a pump, a valve, or a carburetor; and
wherein the mechanical component is associated with an automobile, a watercraft, an aircraft, construction equipment, or an electronic device.

15. The method of claim 12, wherein the method further comprises a step of:
annotating at least one of the retaining materials, the annotating comprising the imprinting of the mechanical component onto at least one of the retaining materials.

16. The method of claim 12, wherein the method further comprises a step of:
affixing a pictorial label resembling the mechanical component onto at least one of the retaining materials.

17. The method of claim 11, wherein the base portion of each of the at least two fastener receptacle units comprises: a mortice operative to receive a tenon associated with the base portion of another fastener receptacle unit, a tenon operative to be received by a mortice associated with the base portion of another fastener receptacle unit, or both; and
wherein the step of assembling the fastener organizer apparatus comprises the mortice of one fastener receptacle unit receiving the tenon of another fastener receptacle unit.

18. The method of claim 11, wherein the at least two fastener receptacle units each further comprise:
a frame, the frame further securing the retaining material.

19. The method of claim 18, wherein the frame of each of the at least two fastener receptacle units defines a first opening operative to receive a pin fastener;
wherein base portion of each of the at least two fastener receptacle units defines a second opening operative to receive the pin fastener and a third opening operative to receive the pin fastener, the first opening of the frame and the second opening of the base portion both being operative to receive the same pin fastener when the fastener receptacle unit is not coupled with another fastener receptacle unit; and
wherein the step of assembling the fastener organizer apparatus comprises the first and second openings of one fastener receptacle unit and the third opening of another fastener receptacle unit receiving the same pin fastener.

20. The method of claim 18, wherein the method further comprises a step of:
annotating a surface of at least one of the frames.

21. The method of claim 11, wherein the fastener organizer further comprises:
a structural unit, the structural unit comprising:
a base portion;
wherein the structural unit is operative to couple with the at least two fastener receptacle units; and
wherein the step of assembling the fastener organizer apparatus further comprises coupling the structural unit with at least one of the at least two fastener receptacle units.

22. The method of claim 21, wherein the base portion of the structural unit comprises an inner surface and an outer surface, the inner surface being operative to receive an accessory feature for disassembling, servicing, or reassembling a mechanical component.
